(19) United States
(12) Patent Application Publication
(10) Pub. No.: US 2026/0015218 A1
(43) Pub. Date: Jan. 15, 2026

(54) END-DAMPENED HYDRAULIC CYLINER

(71) Applicant: Oshkosh Corporation, Oshkosh, WI (US)

(72) Inventors: Todd Werner, Oshkosh, WI (US); Bradley Kresge, Oshkosh, WI (US)

(73) Assignee: Oshkosh Corporation, Oshkosh, WI (US)

(21) Appl. No.: 19/267,455

(22) Filed: Jul. 11, 2025

Related U.S. Application Data
(60) Provisional application No. 63/671,545, filed on Jul. 15, 2024.

(51) Int. Cl. B66F 11/04; B66F 17/00

(52) U.S. Cl. CPC B66F 11/042; B66F 17/006

(57) ABSTRACT

A hydraulic cylinder includes a body defining a bore. The hydraulic cylinder further includes a cylinder rod having an central passage. The hydraulic cylinder further includes a piston coupled to the cylinder rod and disposed within the bore. The hydraulic cylinder further includes a central tube coupled to a first end of the bore and extending into the central passage of the cylinder rod. The central tube includes a first flow orifice positioned adjacent the first end of the bore. The central tube further includes a second flow orifice positioned farther from the first end of the bore than the first flow orifice.

### CROSS-REFERENCE TO RELATED PATENT APPLICATION

This application claims the benefit of and priority to U.S. Provisional Patent Application No. 63/671,545, filed Jul. 15, 2024, which is incorporated herein by reference in its entirety.

### TECHNICAL FIELD

The present disclosure relates generally to hydraulic systems of work machines. More specifically, the present disclosure relates to controlling hydraulic cylinders in hydraulic systems.

### BACKGROUND

Hydraulic cylinders are mechanical actuators that generate force through the use of pressurized hydraulic fluid. They generally consist of a bore or cylindrical barrel, a piston, and a piston or cylinder rod, and are designed to convert fluid pressure into linear motion. Hydraulic cylinders are widely used in various industrial applications, including construction equipment, manufacturing machinery, automotive systems, and aerospace technology, due to their ability to provide precise control and high power output. Their versatility and efficiency make them useful components in systems requiring controlled movement and force.

### SUMMARY

At least one embodiment relates to a hydraulic cylinder. The hydraulic cylinder includes a body defining a bore. The hydraulic cylinder further includes a cylinder rod having an central passage. The hydraulic cylinder further includes a piston coupled to the cylinder rod and disposed within the bore. The hydraulic cylinder further includes a central tube coupled to a first end of the bore and extending into the central passage of the cylinder rod. The central tube includes a first flow orifice positioned adjacent the first end of the bore. The central tube further includes a second flow orifice positioned farther from the first end of the bore than the first flow orifice.

Another embodiment relates to a lift actuator for a work machine or vehicle. The lift actuator includes a hydraulic cylinder. The hydraulic cylinder includes a body defining a bore. The hydraulic cylinder further includes a cylinder rod having an central passage. The hydraulic cylinder further includes a piston coupled to the cylinder rod and disposed within the bore. The hydraulic cylinder further includes a central tube coupled to a first end of the bore and extending into the central passage of the cylinder rod. The central tube includes a plurality of flow orifices positioned along a length of the central tube.

Another embodiment relates to a work machine. The work machine includes a hydraulic cylinder. The hydraulic cylinder includes a body defining a bore. The hydraulic cylinder further includes a cylinder rod having an central passage. The hydraulic cylinder further includes a piston coupled to the cylinder rod and disposed within the bore. The hydraulic cylinder further includes a central tube coupled to a first end of the bore and extending into the central passage of the cylinder rod. The central tube includes a first flow orifice. The central tube further includes a second flow orifice positioned farther from a first end of the bore than the first flow orifice.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a lift device, according to an exemplary embodiment;

FIG. 2 is a schematic diagram of the lift device of FIG. 1, according to an exemplary embodiment;

FIG. 3 is a cross-sectional view of a hydraulic cylinder of the lift device of FIG. 1 in a fully retracted position, according to an exemplary embodiment;

FIG. 4 is a cross-sectional view of the hydraulic cylinder of FIG. 3 in a fully extended position, according to an exemplary embodiment;

FIG. 5 is a cross-sectional view of the hydraulic cylinder of FIG. 3 in a retracted, full flow position, according to an exemplary embodiment;

FIG. 6 is a cross-sectional view of the hydraulic cylinder of FIG. 3 in a retracted, restricted flow position, according to an exemplary embodiment;

FIG. 7 is a cross-sectional detail view of the hydraulic cylinder of FIG. 3 in a fully retracted position, according to an exemplary embodiment;

FIG. 8 is a detail view of a central tube for use with the hydraulic cylinder of FIG. 3, according to an exemplary embodiment;

FIG. 9 is a detail view of another central tube for use with the hydraulic cylinder of FIG. 3, according to an exemplary embodiment;

FIG. 10 is a detail view of another central tube for use with the hydraulic cylinder of FIG. 3, according to an exemplary embodiment;

FIG. 11 is a detail view of another central tube for use with the hydraulic cylinder of FIG. 3, according to an exemplary embodiment; and

FIG. 12 is a detail view of another central tube for use with the hydraulic cylinder of FIG. 3, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a work machine (e.g., a scissor lift, an aerial work platform, a refuse vehicle, a boom lift, a telehandler, etc.) includes a hydraulic system that converts hydraulic energy into linear and/or rotational movement. The hydraulic system includes one or more hydraulic cylinders configured to move one or more components of the work machine. At least one of the hydraulic cylinders includes a central rod having various flow orifices that collectively provide a movement damping effect by reducing a flow rate of hydraulic fluid flowing within the hydraulic cylinder. This movement damping effect effectively prevents slamming and/or other undesirable sudden braking that might otherwise be experienced when the hydraulic cylinder reaches certain positions (e.g., a fully retracted position).

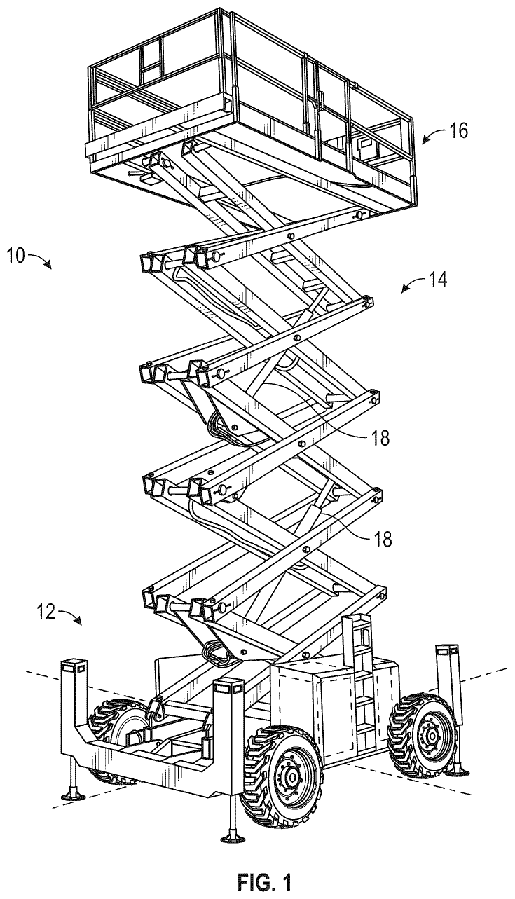

According to the exemplary embodiment shown in FIG. 1, a work machine, shown as lift device 10, includes a chassis, shown as frame assembly 12. A lift assembly (e.g., a scissor assembly, a boom assembly, etc.), shown as lift assembly 14, couples the frame assembly 12 to a platform, shown as platform 16. The frame assembly 12 supports the lift assembly 14 and the platform 16, both of which are disposed directly above the frame assembly 12. In use, the lift assembly 14 extends and retracts to raise and lower the platform 16 relative to the frame assembly 12 between a lowered position and a raised position.

One or more actuators (e.g., hydraulic cylinders, pneumatic cylinders, motor-driven leadscrews, etc.), shown as lift actuators 18, are configured to extend and retract the lift assembly 14. As shown in FIG. 1, the lift assembly 14 includes a pair of the lift actuators 18. The lift actuators 18 are pivotally coupled to an inner support member of the lift assembly 14 at one end and pivotally coupled to another inner support member of the lift assembly 14 at an opposite end. In other embodiments, the lift assembly 14 includes more or fewer of the lift actuators 18 and/or the lift actuators 18 are otherwise arranged. The lift actuators 18 are configured to actuate the lift assembly 14 to selectively reposition the platform 16 between the lowered position, where the platform 16 is proximate the frame assembly 12, and the raised position, where the platform 16 is at an elevated height. In some embodiments, extension of the lift actuators 18 moves the platform 16 vertically upward (extending the lift assembly 14), and retraction of the lift actuators 18 moves the platform 16 vertically downward (retracting the lift assembly 14). In other embodiments, extension of the lift actuators 18 retracts the lift assembly 14, and retraction of the lift actuators 18 extends the lift assembly 14. The lift device 10 may include various components to drive the lift actuators 18 (e.g., pumps, valves, compressors, motors, batteries, voltage regulators, etc.). Although the lift actuators 18 are shown on a scissor lift (e.g., lift device 10), the work machine may be any type of vehicle or other machine (e.g., a lift device, a refuse vehicle, a dump truck, a crane, a military vehicle, etc.).

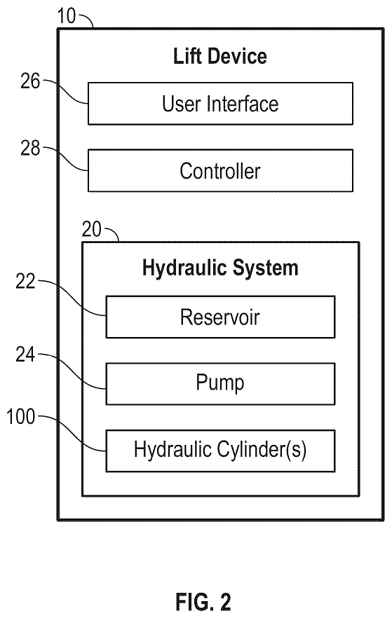

In some instances, as shown in FIGS. 2-7, a hydraulic system 20 of the lift device 10 includes one or more hydraulic cylinders 100 (e.g., hydraulic actuators, linear actuators, etc.) installed or otherwise implemented within the lift actuators 18, which may be utilized to perform various movement functions of the lift device 10, generally by extension and/or retraction of the hydraulic cylinder 100.

As shown in FIG. 1, the hydraulic cylinder 100 may be utilized within the lift actuator 18 of the lift device 10, which is shown as a scissor lift. However, although the hydraulic cylinder 100 is shown within the lift actuator 18 of a scissor lift, it should be understood that the hydraulic cylinder 100 may be utilized in any type of vehicle, equipment, or work machine requiring linear motion. By way of example, the hydraulic cylinder 100 may raise a boom of a boom lift, extend a telescoping boom of a telehandler, rotate a turntable of a fire truck, move an implement, operate a packer or lift arms of a refuse vehicle, etc. The hydraulic cylinder 100 may also control various other work machine or vehicle actions, such as, for example, steering.

Referring to FIG. 2, in some embodiments, the lift device 10 may include the hydraulic system 20 (e.g., a hydraulic circuit) that facilitates the function of the hydraulic cylinders 100. The hydraulic system 20 may include an on-board reservoir tank (e.g., a hydraulic fluid reservoir), shown as reservoir 22, configured to store hydraulic fluid for use within the hydraulic system 20.

The lift device 10 can also include one or more fuel tanks (e.g., pressure vessels, etc.) that store fuel (e.g., CNG fuel, diesel fuel, gasoline fuel, etc.) for use by an engine (e.g., an internal combustion engine, etc.). The fuel may be stored in the one or more fuel tanks as a liquid fuel, a gaseous fuel, or a combination thereof (e.g., a saturated fuel, etc.). The engine may be configured to fluidly couple with the fuel tanks to receive fuel from the tanks, combust the fuel, and drive a hydraulic pump, shown as pump 24. In some instances, the pump 24 may additionally or alternatively be powered by a battery or another on-board electrical system.

The pump 24 is configured to draw or recirculate the hydraulic fluid from the reservoir 22 and provide the hydraulic fluid to one or more of the hydraulic cylinders 100 (e.g., to control the lift actuators 18). The lift device 10 may include one or more control valves (e.g., manually operated, operated by an electronic controller, etc.) that control the speed and direction of fluid flow throughout the hydraulic system 20 to extend or retract the hydraulic cylinders 100.

Various systems of the lift device 10 can be operated by a user through a user interface or human-machine interface (HMI), shown as user interface 26, and a controller (e.g., a processing unit, a processor, etc.), shown as controller 28. The controller 28 may receive user inputs from the user interface 26 and generate control signals for the systems of the lift device 10 (e.g., the engine, the hydraulic system 20, etc.) to perform requested movement functions of the lift device 10. In some embodiments, the controller 28 at least partially controls the pump 24 of the hydraulic system 20 to deliver pressurized hydraulic fluid to accommodate variable pump loads that may be requested during normal vehicle operation.

The controller 28 receives signals from various inputs throughout the lift device 10 and can subsequently control different components within the hydraulic system 20 to execute different tasks. Upon receiving an input requesting an adjustment of the pump load (e.g., requested movement of a system of the lift device 10), the controller 28 can activate or adjust an output of the pump 24 to deliver pressurized hydraulic fluid from the reservoir 22 to the one or more hydraulic cylinders 100 to carry out the requested operation (e.g., selective extension of the lift actuator 18).

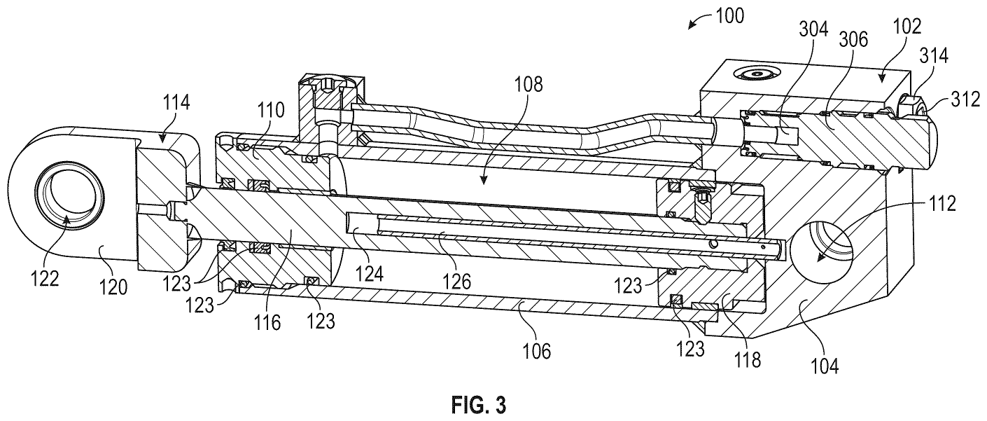

As shown in FIG. 3, the hydraulic cylinder 100 includes a body 102 having a base 104, a tubular member 106 defining a bore 108 or internal volume, and a cap 110 (e.g., an end cap, a cylinder head, etc.). The cap 110 and the base 104 are coupled to opposite ends of the tubular member 106, and the bore 108 is defined between the cap 110 and the base 104. The body 102 is structured as a cylinder or tube encapsulating various components. The base 104 of the body 102 defines a base interface or connection aperture, shown as base interface 112 (e.g., an opening, a hole, etc.), for interfacing with other components of the lift actuator 18 or the lift device 10. For example, a pin may be inserted through the base interface 112 to pivotally couple and/or secure the hydraulic cylinder 100 to another component of the lift actuator 18 or the lift device 10.

The hydraulic cylinder 100 also includes a piston-rod assembly 114 having a cylinder rod 116, a piston 118 or plunger coupled to a first end of the cylinder rod 116, and a cylinder rod cap 120 or clevis coupled to a second end of the cylinder rod 116. The cylinder rod cap 120 includes a cap interface or connection aperture, shown as cylinder rod cap interface 122 (e.g., an opening, a hole, etc.), for interfacing with other components of the lift actuator 18 or the lift device 10. For example, a pin may be inserted through the cylinder rod cap interface 122 to pivotally couple and/or secure the piston-rod assembly or the hydraulic cylinder 100 to another component of the lift actuator 18 or the lift device 10.

The cylinder rod 116, the cap 110, and the piston 118 may include one or more scaling rings (e.g., dynamic seals, o-rings, etc.), shown as sealing ring 123. The one or more sealing rings 123 may be positioned around the circumference of the cylinder rod 116 and the piston 118. As shown, the cylinder rod 116 extends through and is in sliding engagement with the cap 110, and the piston 118 is in sliding engagement with an interior surface of the tubular member 106. The one or more sealing rings 123 may be configured to cushion or seal the interface between the cylinder rod 116 and the cap 110 and the interface between the piston 118 and the inner surface of the tubular member 106. Accordingly, the piston 118 separates the bore 108 into a cap end volume that extends between the piston 118 and the cap 110 and a rod end volume that extends between the piston 118 and cap 110. The one or more sealing rings 123 may also prevent metal-to-metal contact and friction, contamination from debris, etc.

The cylinder rod 116 generally extends along a midline (e.g., middle portion, interior portion, central portion, etc.) of the tubular member 106 from the first end (e.g., near the cap 110) of the body 102 toward the second end (e.g., near the base 104) of the body 102. The piston-rod assembly 114 is positioned coaxially in relation to the tubular member 106 of the hydraulic cylinder 100 and at least partially within the tubular member 106 during various stages of operation (e.g., extension and retraction). For example, as further shown in FIGS. 3-6, portions of the cylinder rod 116 may be positioned within the cap 110, within the bore 108 of the tubular member 106, or outside of the body 102. The piston 118 may be positioned in various positions within the bore 108 of the tubular member 106. The cylinder rod cap 120 may generally be positioned outside of the body 102.

The piston-rod assembly 114 defines a central passage 124 extending along a portion of a length of the piston-rod assembly 114, through the piston 118 and partway through the cylinder rod 116, defining an central passage 124 of the piston-rod assembly 114. The central passage 124 is open on a first end of the piston-rod assembly 114 that faces the base 104 and enclosed on an opposing second end. A central tube 126 (e.g., a tubular member, a cylinder, a conduit, a line, etc.) is fixedly coupled to the base 104 and extends into the central passage 124. In some instances, the central tube 126 is made of a metallic material (e.g., bronze) and is threadedly coupled to a recess formed in the base 104. The central tube 126 slidably engages an internal surface of the central passage 124 to form a seal therebetween that prevents fluid flow between the internal surface of the central passage 124 and the central tube 126. The central passage 124 and the central tube 126 are structured for fluid flow and may contain various fluids (e.g., hydraulic fluid, oil, air, etc.) during operation of the hydraulic cylinder 100.

FIG. 3 depicts the hydraulic cylinder 100 in a fully retracted position. In the fully retracted position, a significant portion of the piston-rod assembly 114 is positioned within the body 102 of the hydraulic cylinder 100. For example, in the fully retracted position, the piston 118 may be positioned at a first end of the bore 108, engaging the base 104 at the first end of the body 102. In this position, the cylinder rod 116 and the piston 118 generally surround a significant portion of the central tube 126 (e.g., a significant portion of the central tube 126 is positioned within central passage 124 formed through the cylinder rod 116 and the piston 118).

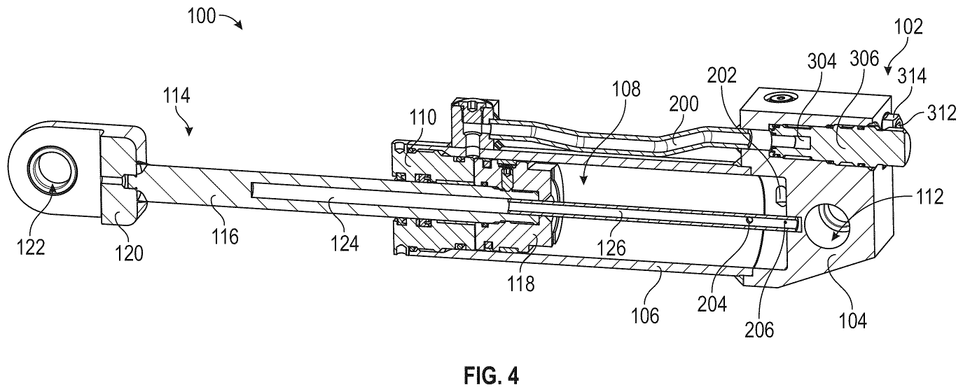

FIG. 4 depicts the hydraulic cylinder 100 in a full extension or fully extended position. In the fully extended position, a significant portion of the cylinder rod 116 is positioned outside of the body 102 of the hydraulic cylinder 100. In this position, the piston 118 is positioned at a second end of the bore 108, adjacent to, against, or otherwise near the cap 110 at the second end of the body 102. In the fully extended position, a significant portion of the central tube 126 is positioned within the bore 108 and outside of central passage 124 of the cylinder rod 116.

As best shown in FIGS. 4-7, the hydraulic cylinder 100 defines a series of passages for fluid flow, shown as a first flow passage 200, a second flow passage 202, a free flow orifice 204, and a restricted flow orifice 206. As further described herein, the one or more passages for fluid flow may contain and pass fluids (e.g., hydraulic oil, air, etc.) between various components of the hydraulic system 20 (e.g., the hydraulic cylinder 100, the pump 24, the reservoir 22).

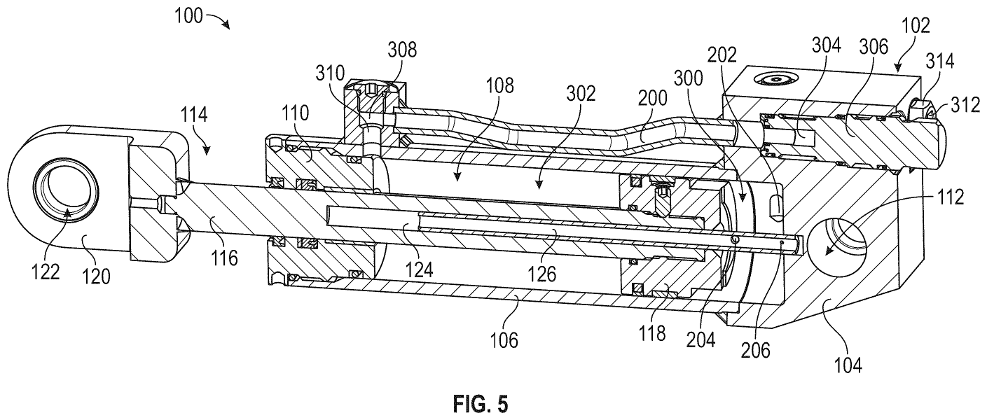

Turning now to FIG. 5, the hydraulic cylinder 100 is shown in a retracted, full flow position (e.g., partially retracted, partially extended, etc.). Extension and retraction of the hydraulic cylinder 100 is controlled by the controller 28 by, for example, selectively pumping hydraulic fluid from the reservoir 22 into different chambers within the bore 108 (e.g., a first chamber 300 and a second chamber 302, as described below) via the pump 24.

In some embodiments, the piston 118 separates the bore 108 into two separate chambers (e.g., volumes) and includes a seal between an outer surface of the piston 118 and an inner surface of the tubular member 106 and/or a valve positioned between the two separate chambers to control the containment or movement of fluids within the bore 108 (e.g., to prevent fluid flow between the separated chambers). As shown in FIG. 5, the piston 118 is positioned to create two chambers within the bore 108, shown as a first volume or cap end chamber, shown as first chamber 300, and a second volume or rod end chamber, shown as second chamber 302. The first chamber 300 is defined by a first face of the piston 118, an inner surface of the tubular member 106, an outer surface of the cylinder rod 116, and an inner surface of the base 104. The second chamber 302 is defined by a second face (e.g., an opposing face) of the piston 118, an inner surface of the tubular member 106, an outer surface of the cylinder rod 116, and an inner surface of the cap 110. Translation of the piston 118 relative to the tubular member 106 (e.g., extension and retraction of the hydraulic cylinder 100) thus changes the volume of the first chamber 300 and the second chamber 302.

As shown in FIGS. 3-6, the first flow passage 200 is in fluid communication with and extends between a first port 304 defined within an first end assembly 306 and a second port 308 in fluid communication with the second chamber 302. Fluid may thus be introduced into or removed from the second chamber 302 through the first port 304 and the second port 308. According to an exemplary embodiment, the second chamber 302 is in fluid communication with the second port 308 through a flow path or conduit (e.g., hose, pipe, etc.), shown as a second port passage 310. The second port passage 310 defines an aperture extending through a sidewall of the tubular member 106 of the body 102. According to an exemplary embodiment, the first port 304 and the second port 308 are positioned along a common side of the hydraulic cylinder 100.

Meanwhile, the second flow passage 202 is in fluid communication with a third port 312 defined within a second end assembly 314. According to an exemplary embodiment, the first chamber 300 is in fluid communication with the third port 312 and the second end assembly 314 through a flow path, shown as the second flow passage 202. As shown in FIGS. 3-6, the second flow passage 202 defines an aperture extending through a sidewall of the tubular member 106 of the body 102. In some instances, instead of the second flow passage 202 being in fluid communication with the third port 312 within the second end assembly 314, the second flow passage 202 may be in fluid communication with the first port 304, and a valve assembly (e.g., a modular valve assembly, etc.) may be arranged within the first port 304 that is configured to selectively deliver hydraulic fluid into the first chamber 300 or the second chamber 302 while simultaneously allowing hydraulic fluid to escape the other of the first chamber 300 or the second chamber 302 (e.g., to return to or otherwise flow back toward the reservoir 22).

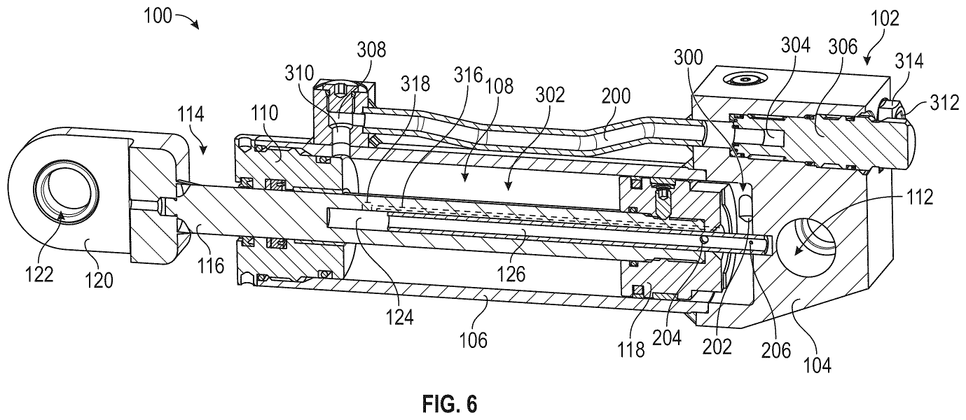

During a first mode of operation of the hydraulic cylinder 100 (e.g., extension), the aforementioned components move relative to one another to move the hydraulic cylinder 100 from a fully retracted position (e.g., shown in FIG. 3) or a partially retracted position (e.g., shown in FIGS. 5 and 6) toward a fully extended position (e.g., shown in FIG. 4). For example, extension of the hydraulic cylinder 100 may be driven by directing pressurized hydraulic fluid into the first chamber 300 and permitting hydraulic fluid to evacuate the second chamber 302. According to an exemplary embodiment, the piston 118 slides away from the base 104 within the bore 108, the volume of the first chamber 300 increases, and the volume of the second chamber 302 decreases.

As the piston-rod assembly 114 extends away from the base 104, the central tube 126 is drawn out of the central passage 124, increasing the open volume within the central passage 124. As this occurs, pressurized hydraulic fluid flows from the second flow passage 202 into the first chamber 300 (e.g., driven by the pump 24), introducing a high pressure into the first chamber 300. Accordingly, in addition to forcing the piston 118 away from the base 104, the hydraulic fluid also flows from the first chamber 300 into the central tube 126, through the free flow orifice 204 and/or the restricted flow orifice 206, and into the newly opened volume within the central passage 124.

During another mode of operation of the hydraulic cylinder 100 (e.g., retraction), the aforementioned components move relative to one another to move the hydraulic cylinder 100 from a fully extended position (e.g., shown in FIG. 4) or a partially retracted position (e.g., shown in FIGS. 5 and 6) to a fully retracted position (e.g., shown in FIG. 3). For example, retraction of the hydraulic cylinder 100 may be driven by directing pressurized hydraulic fluid into the second chamber 302 and permitting fluid to evacuate the first chamber 300. According to an exemplary embodiment, the piston 118 slides away from the cap 110 within the bore 108, the volume of the second chamber 302 increases, and the volume of the first chamber 300 decreases. During this operation, pressurized hydraulic fluid flows from the first port 304, through the first flow passage 200, through the second port passage 310 of the second port 308, and into the second chamber 302. Meanwhile, hydraulic fluid is allowed to escape from the first chamber 300 via the second flow passage 202 and the third port 312.

During retraction of the hydraulic cylinder 100, as the piston 118 slides toward the base 104, the central tube 126 is forced into the central passage 124, decreasing the open volume within the central passage 124 and thereby forcing hydraulic fluid disposed within the central passage 124 to be evacuated through the central tube 126 and into the first chamber 300 via the free flow orifice 204 and/or the restricted flow orifice 206.

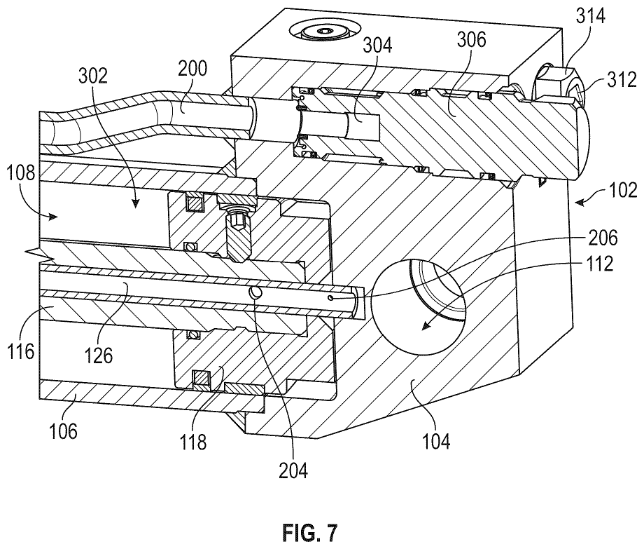

For example, as best illustrated in FIGS. 6 and 7, the central tube 126 defines a series of flow holes, apertures, or passages extending radially through the outer wall of the central tube 126 including the free flow orifice 204 and the restricted flow orifice 206. The flow holes (e.g., the free flow orifice 204 and the restricted flow orifice 206) permit hydraulic fluid from within the central tube 126 to pass out into the first chamber 300 and subsequently be evacuated through the second flow passage 202.

In the embodiment shown in FIGS. 3-7, the restricted flow orifice 206 and the free flow orifice 204 are substantially circular. As shown, the free flow orifice 204 has a first cross-sectional area, and the restricted flow orifice 206 has a second cross-sectional area smaller than the first cross-sectional area (e.g., the diameter of the free flow orifice 204 is greater than the diameter of the restricted flow orifice 206). Accordingly, the restricted flow orifice 206 provides a greater throttling of hydraulic fluid flowing therethrough than the free flow orifice 204. In other words, the larger cross-sectional area of the free flow orifice 204 facilitates hydraulic fluid to flow between the central passage 124 and the first chamber 300 at a faster flow rate compared to the smaller cross-sectional area of the restricted flow orifice 206.

Referring again to FIGS. 6 and 7, the restricted flow orifice 206 is arranged on the central tube 126 adjacent to or otherwise near an inner surface of the base 104 and the free flow orifice 204 is longitudinally offset from the restricted flow orifice 206 on the central tube 126 in an extension direction (e.g., closer to the cap than the restricted flow orifice 206). Accordingly, in the retracted, full flow position (e.g., shown in FIG. 5) the free flow orifice 204 and the restricted flow orifice 206 are both uncovered (e.g., not sealed within or otherwise blocked by an inner surface of the piston 118 or the central passage 124), such that both the free flow orifice 204 and the restricted flow orifice 206 work in tandem to pass fluid between the central passage 124 and the first chamber 300 as the hydraulic cylinder 100 extends or retracts. That is, with both the free flow orifice 204 and the restricted flow orifice 206 uncovered, hydraulic fluid is able to freely flow through the free flow orifice 204 and the restricted flow orifice 206 simultaneously as the hydraulic cylinder 100 extends or retracts.

In FIG. 6, the hydraulic cylinder 100 is depicted in a retracted, restricted flow position (e.g., partially retracted, partially extended, etc.). As shown in FIG. 6, in the retracted, restricted flow position, the free flow orifice 204 is positioned within the piston-rod assembly 114, such that an inner surface of the cylinder rod 116 and/or the piston 118 covers and prevents hydraulic fluid from flowing through the free flow orifice 204. As such, the hydraulic fluid cannot pass freely through the free flow orifice 204 and is instead forced to flow through only the restricted flow orifice 206. This reduces the total available cross-sectional area for the hydraulic fluid to flow through, and this hydraulic fluid flow restriction resists (e.g., slows down) longitudinal movement of the piston-rod assembly 114.

As such, in the retracted, restricted flow position, the configuration of the central tube 126, the free flow orifice 204, the restricted flow orifice 206, the central passage 124, and the piston 118 collectively create a damping force (e.g., a speed reduction force) that opposes movement (e.g., extension, retraction, etc.) of the piston-rod assembly 114. That is, the relative size and spacing of the free flow orifice 204 and the restricted flow orifice 206 in relation to the central tube 126, the central passage 124, and the piston 118 facilitates slowing the movement (e.g., extension or retraction) of the hydraulic cylinder 100 when the hydraulic cylinder 100 is close to or near the fully retracted position (e.g., shown in FIG. 3) once the free flow orifice 204 is covered. This position-dependent damping force or speed reduction force may be advantageous, for example, to prevent slamming and/or other undesirable sudden braking that might otherwise be experienced when the hydraulic cylinder 100 reaches the fully retracted position.

In some embodiments, the flow holes may vary in size. For example, as shown in FIGS. 3-7, the restricted flow orifice 206 (e.g., a first flow hole, a smaller hole, etc.) may be positioned on the central tube 126 at a first location adjacent or near the first end of the bore 108, the first end of the body 102, and the base 104. The free flow orifice 204 (e.g., a second flow hole, a larger hole, etc.) may be positioned on the central tube 126 at a second location that is farther from the first end of the bore 108, the first end of the body 102, and the base 104. In this scenario, as the hydraulic cylinder 100 retracts, the piston 118 and/or the cylinder rod 116 will cover the free flow orifice 204 first, leaving only the restricted flow orifice 206 exposed within the bore 108 when the piston 118 approaches the base 104. Because the restricted flow orifice 206 is smaller (e.g., has a smaller flow area), less fluid can exit via the restricted flow orifice 206, thereby slowing the speed at which the remaining retraction of the hydraulic cylinder 100 can occur. The remaining retraction (e.g., the end of retraction, etc.) of the hydraulic cylinder 100 is thus effectively dampened.

In some embodiments, once the free flow orifice 204 is covered, the damping force or speed reduction force is equally applied both when the hydraulic cylinder 100 is extending and when the hydraulic cylinder 100 is retracting. In other embodiments, the piston-rod assembly 114 (e.g., the cylinder rod 116 and/or the piston 118) includes a bypass channel 316 having a check valve 318 (e.g., shown in FIG. 6) that are collectively configured to provide one-directional fluid communication between the central passage 124 and the first chamber 300. In these embodiments, the bypass channel 316 and the check valve 318 may collectively permit hydraulic fluid to flow freely between the central passage 124 and the first chamber 300 in a first direction (e.g., when extending, when retracting), but prevent the hydraulic fluid from flowing between the central passage 124 and the first chamber 300 in the other direction. Accordingly, in some embodiments, the damping force or speed reduction force may be applied in only one direction.

In some embodiments, the free flow orifice 204 and/or the restricted flow orifice 206 may be arranged differently on the central tube 126 and/or have different sizes, shapes, and/or configurations generally to provide differing levels and/or staggering of damping effects as the hydraulic cylinder 100 is moved between the fully retracted position (e.g., shown in FIG. 3) and the fully extended position (e.g., shown in FIG. 4). That is, the central tube 126 may be modified to have additional, differently sized, differently arranged, and/or differently shaped flow orifices (e.g., similar to the free flow orifice 204 and/or the restricted flow orifice 206) to selectively modify a rate at which hydraulic fluid can pass between the central passage 124 and the first chamber 300 to control the speed at which the hydraulic cylinder 100 is allowed to extend and/or retract to meet the needs of various types of lift devices and/or other work machine or vehicle tasks described herein.

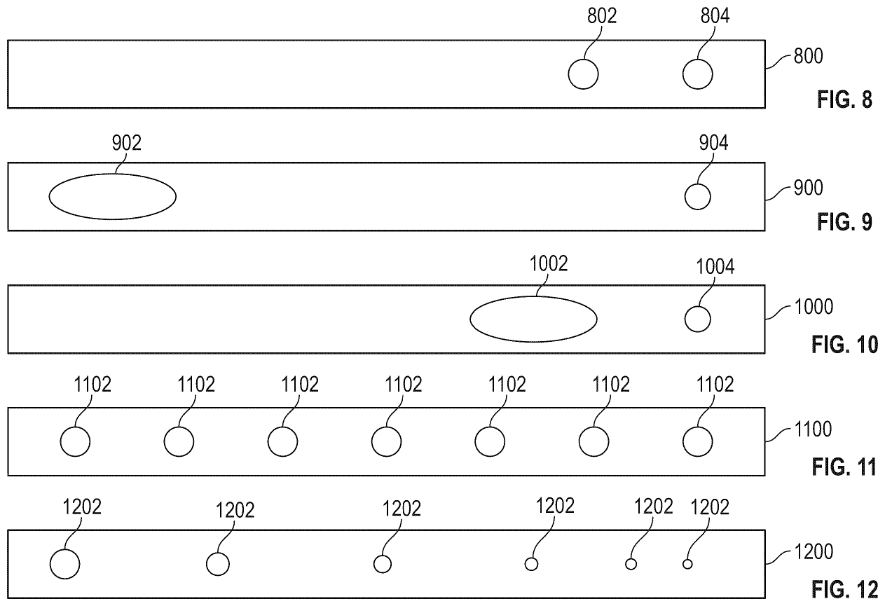

For example, FIGS. 8-12 show a number of different central tubes that may be utilized within the hydraulic cylinder 100 in place of the central tube 126. For example, as shown in FIG. 8, a central tube 800 (e.g., similar to the central tube 126) may include a free flow orifice 802 and a restricted flow orifice 804 that are substantially equal in size. As shown in FIG. 9, a central tube 900 (e.g., similar to the central tube 126) may include a free flow orifice 902 that is generally elliptical or oval in shape. Additionally, while the central tube 900 may include a restricted flow orifice 904 that is positioned similarly to the restricted flow orifice 206 of the central tube 126, the free flow orifice 902 may be substantially farther away from the restricted flow orifice 904 than the free flow orifice 204 is from the restricted flow orifice 206. That is, the free flow orifice 902 may be arranged farther away from the base 104 when assembled (e.g., the right side with respect to FIG. 9) and/or adjacent to or near an opposite end of the central tube 900 from the restricted flow orifice 904. As shown in FIG. 10, a central tube 1000 (e.g., similar to the central tube 126) may include a free flow orifice 1002 and a restricted flow orifice 1004 that are shaped like the free flow orifice 902 and the restricted flow orifice 904, respectively, but are positioned like the free flow orifice 204 and the restricted flow orifice 206, respectively.

In some embodiments, as shown in FIGS. 11 and 12, a central tube may have a plurality of flow orifices arranged along a length of the central tube that are configured to provide a tiered damping effect. For example, as shown in FIG. 11, a central tube 1100 (e.g., similar to the central tube 126) may include a plurality of flow orifices 1102 that are evenly spaced along the central tube 1100 and are evenly sized. Accordingly, when assembled into the hydraulic cylinder 100 in place of the central tube 126 during operation, as the piston-rod assembly 114 moves from the fully extended position toward the retraced position, the plurality of flow orifices 1102 are sequentially covered up by the central passage 124 and/or the piston 118. As such, the hydraulic fluid is initially allowed to pass between the central passage 124 and the first chamber 300 through the combined cross-sectional area of all of the flow orifices 1102. Then, as the flow orifices 1102 are sequentially covered, the hydraulic fluid is only allowed to flow through the combined cross-sectional area of the remaining flow orifices 1102, thereby providing a tiered damping or speed reduction effect that increases as each sequential flow orifice 1102 is covered. Accordingly, with the central tube 1100 installed within the hydraulic cylinder 100, the damping or speed reduction effect is minimized or eliminated completely when the hydraulic cylinder 100 is at or near the fully extended position and is maximized when the hydraulic cylinder 100 is at or near the fully retracted position.

In some instances, as shown in FIG. 12, a central tube 1200 (e.g., similar to the central tube 126) may include a plurality of flow orifices 1202 that are not evenly spaced along the central tube 1200 and/or that are not evenly sized. In the example shown in FIG. 12, the flow orifices 1202 get gradually smaller toward the base 104 (e.g., toward the right side with respect to FIG. 12) and also get gradually closer together toward the base 104. In other examples, various other shapes, sizes, and arrangements of flow orifices 1202 can be incorporated to provide varying rates of damping or speed reduction as the hydraulic cylinder 100 moves between the fully retracted and fully extended positions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components (e.g., the controller 28) used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes instructions (e.g., computer code) for executing (e.g., by the processing circuit or the processor) the one or more processes described herein.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A hydraulic cylinder comprising:
a body defining a bore;
a cylinder rod having an central passage;
a piston coupled to the cylinder rod and disposed within the bore; and
a central tube coupled to a first end of the bore and extending into the central passage of the cylinder rod, the central tube including:
a first flow orifice positioned adjacent the first end of the bore; and
a second flow orifice positioned farther from the first end of the bore than the first flow orifice.

2. The hydraulic cylinder of claim 1, wherein the first flow orifice and the second flow orifice are collectively configured to provide a movement damping effect on the piston and the cylinder rod when the hydraulic cylinder is near a fully retracted position.

3. The hydraulic cylinder of claim 1, wherein the cylinder rod prevents hydraulic fluid from passing through the second flow orifice while allowing the hydraulic fluid to pass through the first flow orifice in at least one position between a fully extended position and a fully retracted position.

4. The hydraulic cylinder of claim 3, wherein, in the at least one position, the first flow orifice is arranged outside of the central passage of the cylinder rod and the second flow orifice is arranged within the central passage of the cylinder rod.

5. The hydraulic cylinder of claim 1, wherein the first flow orifice is a different size than the second flow orifice.

6. The hydraulic cylinder of claim 5, wherein the first flow orifice is smaller than the second flow orifice.

7. The hydraulic cylinder of claim 1, wherein the first flow orifice is a different shape than the second flow orifice.

8. The hydraulic cylinder of claim 7, wherein one of the first flow orifice or the second flow orifice is an oval shape or a circular shape.

9. The hydraulic cylinder of claim 1, wherein the central tube includes a plurality of flow orifices including the first flow orifice, the second flow orifice, and at least one additional flow orifice.

10. A lift actuator for a work machine or vehicle, the lift actuator comprising:
a hydraulic cylinder comprising:
a body defining a bore;
a cylinder rod having an central passage;
a piston coupled to the cylinder rod and disposed within the bore; and
a central tube coupled to a first end of the bore and extending into the central passage of the cylinder rod, the central tube including a plurality of flow orifices positioned along a length of the central tube.

11. The lift actuator of claim 10, wherein the plurality of flow orifices are collectively configured to provide a tiered movement damping effect on the piston and the cylinder rod that increases as the hydraulic cylinder moves from a fully extended position toward a fully retracted position.

12. The lift actuator of claim 10, wherein the plurality of flow orifices are evenly sized.

13. The lift actuator of claim 10, wherein the plurality of flow orifices decrease in size along a length of the central tube.

14. The lift actuator of claim 10, wherein the plurality of flow orifices are evenly spaced along a length of the central tube.

15. The lift actuator of claim 10, wherein the plurality of flow orifices are not evenly spaced along a length of the central tube.

16. A work machine comprising:
a hydraulic cylinder including:
a body defining a bore;
a cylinder rod having an central passage;
a piston coupled to the cylinder rod and disposed within the bore; and
a central tube coupled to a first end of the bore and extending into the central passage of the cylinder rod, the central tube including:
a first flow orifice; and
a second flow orifice positioned farther from a first end of the bore than the first flow orifice.

17. The work machine of claim 16, wherein the first flow orifice and the second flow orifice are collectively configured to provide a movement damping effect on the piston and the cylinder rod when the hydraulic cylinder is near a fully retracted position.

18. The work machine of claim 16, wherein the first flow orifice and the second flow orifice are evenly sized.

19. The work machine of claim 16, wherein the first flow orifice is a different shape than the second flow orifice.

20. The work machine of claim 19, wherein one of the first flow orifice or the second flow orifice is an oval shape or a circular shape.
